(19) United States
(12) Patent Application Publication
(10) Pub. No.: US 2018/0083935 A1
(43) Pub. Date: Mar. 22, 2018

(54) METHOD AND SYSTEM FOR SECURE SMS COMMUNICATIONS

(71) Applicant: Huawei International Pte. Ltd., Singapore (SG)

(72) Inventors: Hui FANG, Shenzhen (CN); Cheng Kang CHU, Singapore (SG); Tieyan LI, Singapore (SG)

(21) Appl. No.: 15/823,971

(22) Filed: Nov. 28, 2017

Related U.S. Application Data
(63) Continuation of application No. PCT/SG2016/050048, filed on Feb. 1, 2016.

(30) Foreign Application Priority Data
May 29, 2015 (SG) SG10201504240V

(51) Int. Cl. H04L 29/06; H04W 12/04; H04W 4/14; H04L 9/08

(52) U.S. Cl. CPC H04L 63/0478; H04W 12/04; H04L 63/0876; H04L 9/0866; H04W 4/14

(57) ABSTRACT

A system and method for securing Short Message Service (SMS) communications between two communication devices disclosed herein. SMS communications between these two communication devices are secured using a SMS encryption technique that utilizes the communication device's unique address as inputs to encrypt and decrypt the SMS messages.

### CROSS-REFERENCE TO RELATED APPLICATIONS

This application is a continuation of International Application No. PCT/SG2016/050048, filed on Feb. 1, 2016, which claims priority to Singapore Patent Application No. SG10201504240V, filed on May 29, 2015. The disclosures of the aforementioned applications are hereby incorporated by reference in their entireties.

### TECHNICAL FIELD APPLICATION

This application relates to a system and method for securing Short Message Service (SMS) communications between two communication devices. More particularly, this application relates to a system and method that implements end-to-end encryption methodology to secure SMS communications between two communication devices.

### BACKGROUND

Text messages may be exchanged between communication devices such as mobile phones or mobile computing devices using a variety of methods. A popular way of sending and receiving such text messages is using a Short Message Service (SMS). A typical SMS message may contain up to 140 bytes of data, which is the equivalent of up to 160 English characters or 70 Chinese characters and SMS utilizes standard telecommunication protocols to allow communication devices to exchange short text messages through Short Message Service Centres.

Short Message Service Centres are responsible for routing and delivering SMS messages to their intended recipients. When a SMS message is delivered to a Short Message Service Centre (SMSC), a store-and-forward message mechanism is initiated at the SMSC whereby the message is temporarily stored and then forwarded to the intended recipient's communication device once the device is available to receive the SMS message. If the intended recipient of the SMS message is not available to receive the SMS message, e.g. the communication device is offline; the SMSC will store the SMS message for a predetermined period of time before deleting the stored SMS message from its memory.

By default, SMS messages are typically not encrypted and as such, if malicious third parties were to intercept these messages during transmission, these third parties would be able to read and/or tamper with the content of these SMS messages easily. In particular, the content of such SMS messages are most vulnerable when the SMS messages are received and are temporarily stored in a SMSC before the message is forwarded on. This is because there is the possibility that the third party may hack into the SMSC to intercept, retrieve, and modify the content of the SMS message before the SMS message is forwarded on to the intended recipient thereby altering the content of the SMS message without the knowledge of the sender or the recipient. Another weakness of existing SMS communication systems is that after a recipient has received and read a received SMS message, the received SMS message is typically stored within the recipient's communication device. If a malicious application has been installed within the recipient's communication device, the malicious application would be able to record all incoming and outgoing SMS messages. The recorded messages may then subsequently be uploaded to a remote server thereby jeopardizing information contained within the communication device.

A method of securing SMS communications has been proposed in U.S. application Ser. No. 12/341,987 titled “Secure SMS communications” by Ebay Inc. as published on 24 Sep. 2013. This document discloses of a system and method for securing SMS communications which involves sending SMS data, which is to be sent from a client device, to a remote location whereby the SMS data is encrypted at the remote location. It is also disclosed that the SMS data is encrypted using a Message Authentication Code (MAC) timestamp and/or a counter together with information obtained from a second factor authentication system. The encrypted SMS data is then sent from the remote location to the intended recipient's device. At the recipient's device, the SMS data is then decrypted using a decryption application provided on the recipient's device. The decryption application utilizes a MAC timestamp and/or counter transmitted together with the encrypted SMS data to decrypt the encrypted SMS data.

Various other approaches to secure SMS communications have also been proposed by those skilled in the art however, these approaches typically involve the prior step of generating both public and private keys and distributing the keys that are to be used between two end users. Such approaches are inconvenient when messages are to be encrypted in real time as a third party server would have to be contacted frequently to obtain the encryption key to encrypt the message.

For the above reasons, those skilled in the art are constantly striving to come up with a system and method to secure SMS communications between devices in an efficient, secure and cost effective manner.

### SUMMARY APPLICATION

The above and other problems are solved and an advance in the art is made by systems and methods provided by embodiments in accordance with the application. A first advantage of embodiments of systems and methods in accordance with this application is that SMS communications between two communication devices may be secured using a SMS encryption technique that utilizes a communication device's unique address to encrypt and decrypt the SMS messages.

A second advantage of embodiments of systems and methods in accordance with this application is that after a communication device has registered with a secure server, the communication device is able to encrypt a SMS message without exchanging further information and/or data with the secure server. This means that once communication devices have completed their respective registration operations with the secure server, these communication devices are able to encrypt and decrypt SMS messages independently.

A third advantage of embodiments of system and methods in accordance with this application is that a communication device is only able to decrypt an encrypted message whereby the communication device is the intended recipient. This means that if a communication device were to be sent an encrypted message meant for another communication device by mistake, the communication device would not be able to decrypt the received encrypted message.

The above advantages are provided by embodiments of a method for supporting secure Short Message Service communications between a first communication device and a second communication device in accordance with the application. The method comprises the steps of encrypting plaintext by an encryption module provided at the first communication device, wherein the plaintext is encrypted using a public key associated with the second communication device, and wherein the public key associated with the second communication device is generated at the encryption module using a global public key and a unique address associated with the second communication device, encapsulating the encrypted plaintext into a Short Message Service message, using a Short Message Service module provided at the first communication device, and setting a pattern at a first byte of the encapsulated encrypted plaintext to indicate a presence of encrypted plaintext and sending the Short Message Service message from the first communication device to the second communication device. The method further comprises the steps of determining, using a Short Message Service module provided at the second communication device, if the Short Message Service message received at the second communication device contains encrypted plaintext, decrypting the encrypted plaintext encapsulated within the Short Message Service message using a decryption module provided at the second communication device, in response to a determination that the Short Message Service message received at the second communication device contains encrypted plaintext, wherein the encrypted plaintext is decrypted using a private key associated with the second communication device, wherein the global public key is and the private key associated with the second communication device is obtained from a secure server during registration operations between the first communication device and the second communication device with a secure server.

In accordance with embodiments of the application, the registration operations between the first communication device and the second communication device with the secure server comprises the steps of retrieving and sending the global public key from the secure server to the first communication device in response to the secure server receiving a registration request from the first communication device, and generating the private key associated with the second communication device at the secure server using a master key and the unique address associated with the second communication device, and sending the generated private key from the secure server to the second communication device in response to the secure server receiving a registration request from the second communication device.

In accordance with embodiments of the application, the method further includes the step of generating a private key associated with the first communication device at the secure server using the master key and a unique address associated with the first communication device, and sending the generated private key from the secure server to the first communication device in response to the secure server receiving a registration request from the second communication device.

In accordance with embodiments of the application, further includes the steps of retrieving and sending the global public key from the secure server to the second communication device in response to the secure server receiving a registration request from the second communication device.

In accordance with embodiments of the application, the encryption module uses identity based encryption to encrypt the plaintext and the decryption module uses identity based decryption to decrypt the encrypted plaintext.

In accordance with embodiments of the application, the method of determining if the Short Message Service message received at the second communication device contains encrypted plain text comprises the steps of checking, using the Short Message Service module provided at the second communication device, if a flag provided at a first byte of the encapsulated encrypted plaintext in the Short Message Service message is set to indicate the presence of encrypted plain text.

### BRIEF DESCRIPTION OF THE DRAWINGS

The above advantages and features in accordance with this application are described in the following detailed description and are shown in the following drawings:

FIG. 1 illustrating a schematic of a system in accordance with an embodiment of the application;

FIG. 2 illustrating a block diagram of modules provided within a communication device in accordance with embodiments of the application;

FIG. 3 illustrating a timing diagram of registration operations between communication devices and a secure server;

FIG. 4 illustrating a flow diagram of a process for encrypting a SMS message at a communication device in accordance with embodiments of the application;

FIG. 5 illustrating a flow diagram of a process for decrypting a received SMS message at a communication device in accordance with embodiments of the application; and

FIG. 6 illustrating a block diagram representative of processing systems providing embodiments in accordance with embodiments of the application.

### DESCRIPTION OF EMBODIMENTS

This application relates to a system and method for securing Short Message Service (SMS) communications between two communication devices by implementing end-to-end encryption methodology to secure SMS communications. As a result, SMS communications between two communication devices may be secured using a SMS encryption technique that utilizes a communication device's unique address to encrypt and decrypt the SMS messages. Further, it should be noted that after a communication device has registered with a secure server, the communication device is able to encrypt a SMS message without exchanging further information and/or data with the secure server. This means that once communication devices have completed the registration operation with the secure server, these communication devices are able to encrypt and decrypt SMS messages independently. In addition to above, a communication device is only able to decrypt an encrypted message whereby the communication device is the intended recipient. This means that if a communication device were to be sent an encrypted message meant for another communication device erroneously, the communication device would not be able to decrypt the received encrypted message.

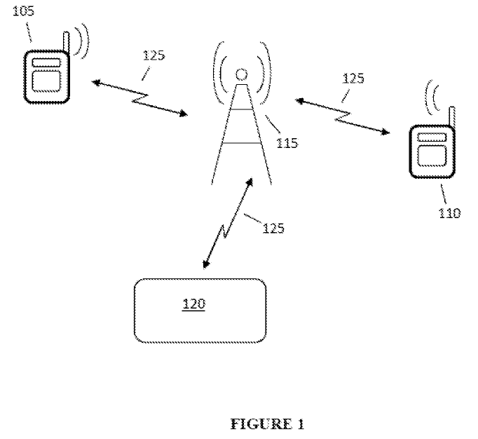

FIG. 1 illustrates devices that execute processes to provide a secure SMS message communications system in accordance with this application. The system shown in FIG. 1 illustrates communication device 105 exchanging SMS messages with communication device 110. Communication devices 105 and 110 may include mobile communication devices such as cellular telephones, tablets and/or computing devices such as personal computers, portable computers, and hand-held computers. SMS messages may be exchanged between communication devices 105 and 110 through network 125. Network 125 is a communications network that allows communication devices to communicate with one another and network 125 may include, but is not limited to, telephone networks such as GSM, 3G, 4G, GPRS networks, or other types of communication networks such as the Internet, a local area network, a wide area network, a public switched telephone network, a virtual private network, a wired network, a wireless network, leased line networks, fibre optic or cable based networks, or any other suitable network technology that is able to support the transmission of SMS messages from a sender to its intended recipient.

FIG. 1 also illustrates secure server 120 which is communicatively connected to communication devices 105 and 110 via network 125. Secure server 120 may comprise one or more computers servers or cloud computer server systems that are connected to one or more storage mediums to store and process data received from various sources. These storage mediums may be a part of secure server 120 or these storage mediums may be located at another location and linked to secure server 120 through network 125. Secure server 120 is also provided with a private key generation module and a public key generation module. The function of private key generation module is to generate a private key for a communication device based on the communication device's unique address when the module receives a private key generation request from the communication device. As for the public key generation module, the function of this module is to either generate and/or assign a public key associated with the private key that was previously generated for the communication device. The generated private key and the associated public key will then be transmitted to the requesting device.

Although FIG. 1 only illustrates that two communication devices are provided within the system, which are communication devices 105 and 110, one skilled in the art will recognize that any number of communication devices may be provided within this system without departing from this application. Similarly, although FIG. 1 only illustrates one secure server, one skilled in the art will recognize that more than one secure server may be provided. For example, communication device 105 may request for a private key and public key from a secure server that is located geographically nearer to the device's present location while communication device 110 may request for a private key and public key from another secure server that may be located geographically nearer to it.

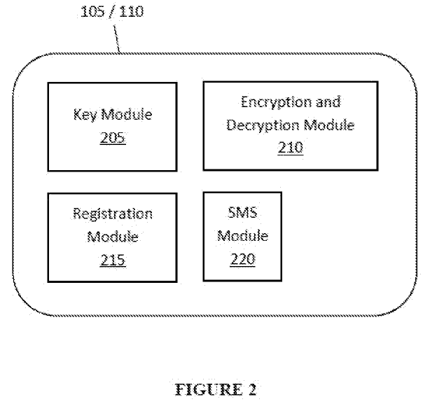

FIG. 2 illustrates a block diagram of modules provided within communication devices 105 and 110. Key module 205 is a computing module for storing the communication device's private key and public key. As key module 205 stores sensitive data, this module is normally a secure and tamper proof module that is password protected and may only be accessed by the primary user of the communication device. Encryption and decryption module 210 is a computing module for carrying out encryption and decryption operations using information contained within key module 205. The encryption and decryption operations implemented in encryption and decryption module 210 may be executed using any suitable identity based encryption schemes that utilize cryptographic algorithms and have security proofs, such as, but not limited to, quadratic residues or elliptic curves to utilize the relevant private keys to generate the associated public keys. For example, the Boneh-Franklin identity based encryption scheme is based on bilinear pairings on elliptic curves, while the Cocks identity based encryption scheme is based on quadratic residues.

Registration module 215 is a computing module that is utilized by a communication device to transmit a registration request to secure server 120. Registration module 215 is also provided with an algorithm for determining the most secure and/or fastest data route between the communication device and the secure server. For example, if the communication device is located in Australia and the secure server is located in the United States, it would be more cost effective and would be faster if the request were to be sent to the secure server through the Internet as compared to utilizing conventional telecommunications networks to transmit the request. However, for security reasons, when data is transmitted back to the communication device from the secure server, this data will only be transmitted through telecommunication networks as the secure server will send the data to the communication device using the device's unique address. In accordance with embodiments of the application, a communication device's unique address may comprise the device's fixed line telephone number or the device's mobile phone number. The final module illustrated in FIG. 2 is SMS module 220, which is a conventional module for entering, generating and sending SMS messages and for receiving and displaying SMS messages on the communication device.

Prior to initiating registration operations between communication devices 105, 110 and secure server 120, a computing module within secure server 120 will first generate a master key that is to be subsequently used by the private key generation module to generate private keys for the various users of the system. In accordance with embodiments of the application, the master key may be generated within secure server 120 using a random number generator and this generated master key will then be stored within a tamper proof module within secure server 120. Alternatively, in other embodiments of the application, the master key may be generated offsite, at a secure remote location, and may then be subsequently inserted into the tamper proof module within secure server 120 for future use. It should be noted that multiple master keys may be generated and/or may be stored within the tamper proof module without departing from this application. For example, secure server 120 may assign a first master key for all secure SMS communications that take place between communication devices A, B, C, and D, and secure server 120 may assign a different master key, e.g. a second master key, for all secure SMS communications that take place between communication devices V, X, Y, and Z. This is to ensure that in the unlikely event a hacker is able to guess or obtain the master key that is being used for SMS communications between devices A and B, this will not result in SMS communications between other parties, e.g. V, X, Y and Z, being compromised.

After the master key has been generated and/or stored in the tamper proof module within secure server 120, the public key generation module within secure server 120 will then generate a global public key that is to be associated with the newly generated or stored master key. In accordance with embodiments of the application, the global public key may be generated using a random number generator and the master key. This generated global public key is then also stored within the tamper proof module within secure server 120. It should also be noted that multiple global public keys may be generated and/or may be stored within the tamper proof module without departing from this application.

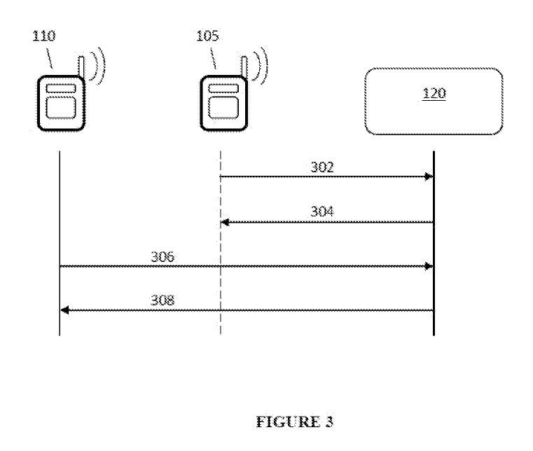

FIG. 3 illustrates the initial registration operations that take place between communication devices 105, 110 and secure server 120. As illustrated in FIG. 3, the registration operation between communication device 105 and secure server 120 begins at step 302. At step 302, communication device 105 sends a registration request to secure server 120. This registration request may be sent as a SMS message, as a data message transmitted via the Internet or as an e-mail. It is important that the communication device's unique address, e.g. telephone number or mobile phone number, be included within this request as the response from secure server 120 will be sent to the unique address provided in the registration request. In addition to the above, the unique address will also be used by secure server 120 in the generation of the private key for communication device 105.

Upon receiving the registration request, the private key generator within secure server 120 will then generate a private key for communication device 105 using the master key contained within the tamper proof module and the unique address of communication device 105. In accordance with embodiments of the application, the private key of communication device 105 may be generated as the product of the master key with a mapping point derived from the unique address of communication device 105 wherein the master key comprises an algebraic number.

Once the private key of communication device 105 has been generated, this private key and the global public key will be sent as a SMS message from secure server 120 to communication device 105 using the unique address provided. The transmission of these parameters from secure server 120 to communication device 105 occurs at step 304.

Similarly, before communication device 110 is able to utilize the secure SMS communication system, communication device 110 will first have to initiate registration operations with secure server 120. The registration request is transmitted from communication device 110 to secure server 120 at step 306. As mentioned above, this registration request may be sent as a SMS message, as a data message transmitted via the Internet or as an e-mail. The unique address of communication device 110 also has to be included within this request. Upon receiving the registration request, the private key generator within secure server 120 will then generate a private key for communication device 110 using the master key contained within the tamper proof module and the unique address of communication device 110. Once the private key of communication device 110 has been generated, this private key and the global public key will be sent as a SMS message from secure server 120 to communication device 110. The transmission of these two parameters occurs at step 308. Once these two communication devices have completed registration operations with secure server 120, these two communication devices may now be utilized to send and/or to receive secure SMS communications.

When communication device 105 is utilized to send a secure SMS message to communication device 110, communication device 105 will first generate a public key associated with communication device 110. The public key associated with communication device 110 will be generated using the unique address of communication device 110, e.g. the telephone number or mobile phone number of communication device 110, and the global public key as provided by secure server 120. Once the public key of communication device 110 has been created, the plain text of the text message is then encrypted using identity based encryption techniques whereby the public key associated with communication device 110 is used as the input for this encryption technique. The encrypted text is then encapsulated into the frame body of a standard SMS message.

In accordance with embodiments of the application, the first byte of the body of the SMS message is used as a “flag” to indicate whether the text contained within the SMS message is encrypted or not. For example, if the first byte shows a “00001111” pattern, this indicate that the text contained within is encrypted and if the first byte shows any other patterns, this indicates that the text contained within is plain text that has not been encrypted. One skilled in the art will recognize that any other patterns may be utilized as the flag byte without departing from this application provided that the flag byte has a unique pattern that does not appear in the first byte of the frame body in conventional SMS messages. The final SMS message is then sent to communication device 110.

Upon receiving the SMS message from communication device 105, communication device 110 will first determine whether the received SMS message is a secure SMS message that has been encrypted in accordance with embodiments of this application or a conventional SMS message. Communication device 110 does this by matching the first byte in the frame body of the received SMS message with a predetermined pattern stored within a database or memory of communication device 110. If a match is not found, this indicates that the SMS message is not encrypted. Alternatively, if a match is found this indicates that the text message is encrypted. Communication device 110 will then utilize its private key, as obtained from secure server 120, to decrypt the encrypted text within the SMS message. Once the message has been decrypted, the decrypted plain text may then be displayed by communication device 110.

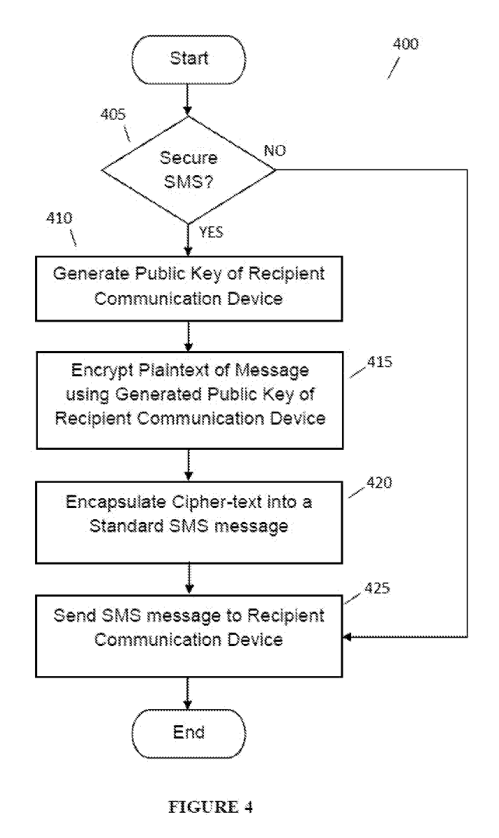

FIG. 4 illustrates process 400 that is performed by a computing module in a communication device to encrypt plaintext and to send the encrypted plaintext as a secure SMS message to an intended recipient in accordance with embodiments of this application. For illustration purposes, it shall be assumed that communication device 110 is the intended recipient of a secure SMS message from communication device 105. Process 400 begins at step 405 whereby process 400 determines whether a text message is to be sent as a conventional SMS message or as a secure SMS message. If process 400 determines that the text message is to be sent as a conventional SMS message, process 400 proceeds to step 425 whereby the SMS message is sent to communication device 110 using conventional methods and process 400 then ends. Alternatively, if process 400 determines that the text message is to be sent as a secure SMS message, process 400 will proceed to step 410.

At step 410, process 400 will generate a public key associated with communication device 110 using a unique address of communication device 110, e.g. the telephone number or mobile phone number of the intended recipient, together with the global public key as provided by the secure server. In accordance with embodiments of the application, the public key associated with communication device 110 may be generated by pairing the global public key with a mapping point derived from the unique address of communication device 110 in a bilinear space.

Process 400 then proceeds to step 415 whereby the plain text of the text message is encrypted using identity based encryption techniques whereby the public key associated with communication device 110 is used as the input for this encryption technique. In accordance with an embodiment of the application, the text message is encrypted in the following manner using the public key associated with communication device 110. First, a random number, r, is selected. The rth order exponential of the public key associated with the intended recipient is then computed. The exclusive addition, or XOR, of the plain text in the text message with the computed rth order exponential of the public key associated with the intended recipient is then obtained. Finally, the result obtained from the exclusive addition of the plain text in the text message with the computed rth order exponential together with a mapping point derived from random number, r, is used as the final cipher text.

Process 400 then encapsulates the encrypted text into the frame body of a standard SMS message at step 420. The first byte of the body of the SMS message is used as a “flag” to indicate whether the text contained within the SMS message is encrypted or not. For example, if the first 8 bits show a “00001111” pattern, this could indicate that the text contained within is encrypted and that if the first 8 bits show any other patterns, this would mean that the text contained within is plain text that has not been encrypted. One skilled in the art will recognize that any other patterns may be utilized as the flag byte without departing from this application provided that the flag byte has a unique pattern that does not appear in the first byte of the frame body in conventional SMS messages. The secure SMS message is then sent to the intended recipient communication device at step 425.

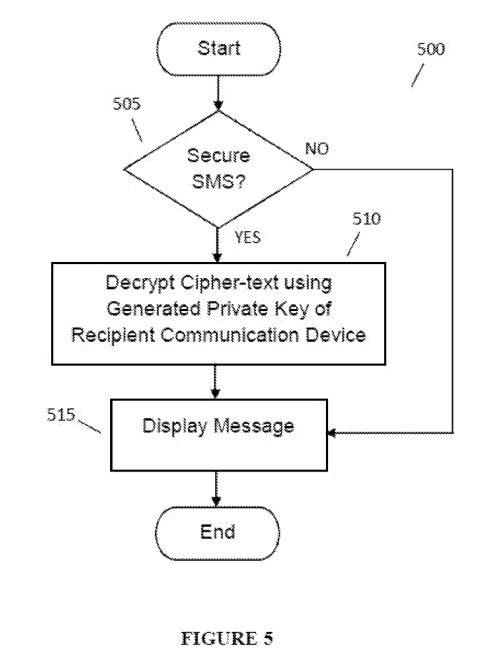

FIG. 5 illustrates process 500 that is performed by a computing module in a communication device to decrypt encrypted plaintext within a received SMS message in accordance with embodiments of this application. For illustration purposes, it shall be assumed that communication device 110 received a secure SMS message from communication device 105. Process 500 begins at step 505 whereby process 500 determines whether a received SMS message is a secure SMS message that has been encrypted in accordance with embodiments of this application or a conventional SMS message. Process 500 carries out this determination step by matching the first byte in the frame body of the SMS message with a predetermined pattern stored within the communication device's database or memory. If a match is not found, this indicates that the SMS message is not encrypted and process 500 proceeds to step 515. At step 515, the received SMS message is displayed on the communication device and process 500 ends.

If at step 505 process 500 determines that the pattern of the first byte in the frame body of the SMS message contains an indication that the text message is encrypted, process 500 will then proceed to step 510 instead.

At step 510, process 500 will utilize a private key associated with communication device 110 to decrypt the encrypted text within the SMS message. In accordance with an embodiment of the application, for a pairing based instance, the encrypted text, or cipher text, will be split into two segments. The first segment will be paired with the private key associated with communication device 110 to create a new segment. This new segment will then be exclusively added to the original second segment to recover the plaintext message. It should be noted that process 500 will only be able to decrypt the encrypted text if the received secure SMS message was intended for communication device 110. This is because the plain text within the SMS message would have been encrypted using the unique address of the recipient communication device together with the global public key. Once the message has been decrypted, process 500 will then proceed to step 515 whereby the message will be displayed on the communication device. Process 500 then ends.

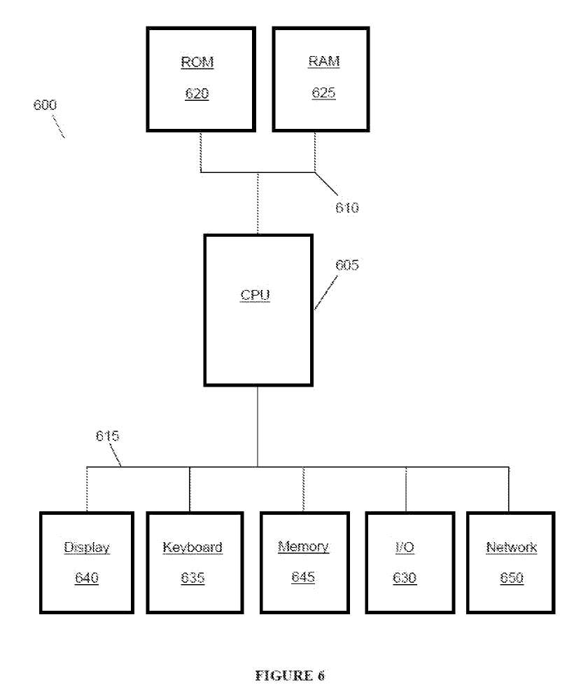

The processes described above may be provided by instructions stored in a non-transitory media and these instructions may be executed by a processing unit in a computer system. For the avoidance of doubt, non-transitory computer-readable media shall be taken to comprise all computer-readable media except for a transitory, propagating signal. A computer system may be provided in one or more computing devices and/or computer servers to provide this application. The instructions may be stored as firmware, hardware, or software. FIG. 6 illustrates an example of such a processing system. Processing system 600 may be the processing system in the communication devices and/or secure servers that execute the instructions to perform the processes for providing a method and/or system in accordance with embodiments of this application. One skilled in the art will recognize that the exact configuration of each processing system may be different and the exact configuration of the processing system in each mobile device may vary and FIG. 6 is given by way of example only.

Processing system 600 includes Central Processing Unit (CPU) 605. CPU 605 is a processor, microprocessor, or any combination of processors and microprocessors that execute instructions to perform the processes in accordance with the present application. CPU 605 connects to memory bus 610 and Input/Output (I/O) bus 615. Memory bus 610 connects CPU 705 to memories 620 and 625 to transmit data and instructions between memories 620, 625 and CPU 605. I/O bus 615 connects CPU 605 to peripheral devices to transmit data between CPU 605 and the peripheral devices. One skilled in the art will recognize that I/O bus 615 and memory bus 610 may be combined into one bus or subdivided into many other busses and the exact configuration is left to those skilled in the art.

A non-volatile memory 620, such as a Read Only Memory (ROM), is connected to memory bus 610. Non-volatile memory 620 stores instructions and data needed to operate various sub-systems of processing system 600 and to boot the system at start-up. One skilled in the art will recognize that any number of types of memory may be used to perform this function.

A volatile memory 625, such as Random Access Memory (RAM), is also connected to memory bus 610. Volatile memory 625 stores the instructions and data needed by CPU 605 to perform software instructions for processes such as the processes required for providing a system in accordance with embodiments of this application. One skilled in the art will recognize that any number of types of memory may be used as volatile memory and the exact type used is left as a design choice to those skilled in the art.

I/O device 630, keyboard 635, display 640, memory 645, network device 650 and any number of other peripheral devices connect to I/O bus 615 to exchange data with CPU 605 for use in applications being executed by CPU 605. I/O device 630 is any device that transmits and/or receives data from CPU 605. Keyboard 635 is a specific type of I/O that receives user input and transmits the input to CPU 605. Display 640 receives display data from CPU 605 and display images on a screen for a user to see. Memory 645 is a device that transmits and receives data to and from CPU 605 for storing data to a media. Network device 650 connects CPU 605 to a network for transmission of data to and from other processing systems.

The above is a description of embodiments of a system and process in accordance with the present application as set forth in the following claims. It is envisioned that others may and will design alternatives that fall within the scope of the following claims.

What is claimed is:

1. A method for supporting secure Short Message Service communications between a first communication device and a second communication device, the method comprising:
encrypting plaintext by an encryption module provided at the first communication device, wherein the plaintext is encrypted using a public key associated with the second communication device, and wherein the public key associated with the second communication device is generated at the encryption module using a global public key and a unique address associated with the second communication device;
encapsulating the encrypted plaintext into a Short Message Service message and setting a pattern at a first byte of the encapsulated encrypted plaintext to indicate a presence of encrypted plaintext using a Short Message Service module provided at the first communication device;
sending the Short Message Service message from the first communication device to the second communication device;
determining, using a Short Message Service module provided at the second communication device, if the Short Message Service message received at the second communication device contains encrypted plaintext;
decrypting the encrypted plaintext encapsulated within the Short Message Service message using a decryption module provided at the second communication device, in response to a determination that the Short Message Service message received at the second communication device contains encrypted plaintext, wherein the encrypted plaintext is decrypted using a private key associated with the second communication device,
wherein the global public key is and the private key associated with the second communication device is obtained from a secure server during registration operations between the first communication device and the second communication device with a secure server.

2. The method according to claim 1 wherein the registration operations between the first communication device and the second communication device with the secure server comprise:
retrieving and sending the global public key from the secure server to the first communication device in response to the secure server receiving a registration request from the first communication device; and
generating the private key associated with the second communication device at the secure server using a master key and the unique address associated with the second communication device, and sending the generated private key from the secure server to the second communication device in response to the secure server receiving a registration request from the second communication device.

3. The method according to claim 2 further comprising:
generating a private key associated with the first communication device at the secure server using the master key and a unique address associated with the first communication device, and sending the generated private key from the secure server to the first communication device in response to the secure server receiving a registration request from the second communication device.

4. The method according to claim 2 further comprising:
retrieving and sending the global public key from the secure server to the second communication device in response to the secure server receiving a registration request from the second communication device.

5. The method according to claim 1 wherein the encryption module uses identity based encryption to encrypt the plaintext and the decryption module uses identity based decryption to decrypt the encrypted plaintext.

6. The method according to claim 1 wherein the determining if the Short Message Service message received at the second communication device contains encrypted plain text comprises:
checking, using the Short Message Service module provided at the second communication device, if a flag provided at a first byte of the encapsulated encrypted plaintext in the Short Message Service message is set to indicate the presence of encrypted plain text.

7. A system for supporting secure Short Message Service communications between a first communication device and a second communication device, the system comprising:
a processing unit provided at the first communication device; and
a non-transitory media readable by the processing unit, the media storing instructions that when executed by the processing unit, cause the processing unit to:
encrypt plaintext using a public key associated with the second communication device, wherein the public key associated with the second communication device is generated using a global public key and a unique address associated with the second communication device;
encapsulate the encrypted plaintext into a Short Message Service message and set a pattern at a first byte of the encapsulated encrypted plaintext to indicate a presence of encrypted plaintext;
send the Short Message Service message to the second communication device;
a processing unit provided at the second communication device; and
a non-transitory media readable by the processing unit, the media storing instructions that when executed by the processing unit, cause the processing unit to:
determine if the Short Message Service message received at the second communication device contains encrypted plaintext;
decrypt the encrypted plaintext encapsulated within the Short Message Service message in response to a determination that the Short Message Service message received at the second communication device contains encrypted plaintext, wherein the encrypted plaintext is decrypted using a private key associated with the second communication device,
wherein the global public key is and the private key associated with the second communication device is obtained from a secure server during registration operations between the first communication device and the second communication device with the secure server.

8. The system according to claim 7 wherein the secure server comprises:
a processing unit; and
a non-transitory media readable by the processing unit, the media storing instructions that when executed by the processing unit, cause the processing unit to:
retrieve and send the global public key to the first communication device in response to the secure server receiving a registration request from the first communication device; and
generate the private key associated with the second communication device at the secure server using a master key and the unique address associated with the second communication device, and sending the generated private key from the secure server to the second communication device in response to the secure server receiving a registration request from the second communication device.

9. The system according to claim 8 wherein the instructions further comprises:
instructions for directing the processing unit to:
generate a private key associated with the first communication device at the secure server using the master key and a unique address associated with the first communication device, and sending the generated private key from the secure server to the first communication device in response to the secure server receiving a registration request from the second communication device

10. The system according to claim 8 wherein the instructions further comprises:
instructions for directing the processing unit to:
retrieve and send the global public key from the secure server to the second communication device in response to the secure server receiving a registration request from the second communication device.

11. The system according to claim 7 wherein the plain text is encrypted using identity based encryption and the encrypted plaintext is decrypted using identity based decryption.

12. The system according to claim 7 wherein the instructions to determine if the Short Message Service message received at the second communication device contains encrypted plain text comprises:
instructions for directing the processing unit provided at the second communication device to:
checking if a flag provided at a first byte of the encapsulated encrypted plaintext in the Short Message Service message is set to indicate the presence of encrypted plain text.

13. A method for secure Short Message Service communications between a first communication device and a second communication device by a secure server, the method comprising:
providing a global public key to the first communication device in response to the secure server receiving a registration request from the first communication device, wherein the global public key and a unique address associated with the second communication device is used by the first communication device to generate a public key associated with the second communication device, and
wherein in response to the first communication device receiving a request to encrypt plaintext:
the generated public key associated with the second communication device is used by the first communication device to encrypt the plaintext;
the encrypted plaintext is encapsulated by the first communication device into a Short Message Service message and a pattern at a first byte of the encapsulated encrypted plaintext is set by the first communication device to indicate a presence of encrypted plaintext, and
the Short Message Service message is sent by the first communication device to the second communication device;
providing a private key associated with the second communication device to the second communication device in response to the secure server receiving a registration request from the second communication device, wherein the private key is used by the second communication device to decrypt encrypted plaintext at the second communication device in response to a determination by the second communication device that a Short Message Service message received at the second communication device contains encrypted plaintext.

14. The method according to claim 13 wherein in response to the secure server receiving a registration request from the first communication device, the method further comprises:
generating a private key associated with the first communication device at the secure server using a master key and a unique address associated with the first communication device, and sending the generated private key from the secure server to the first communication device.

15. The method according to claim 13 wherein the private key associated with the second communication device is generated at the secure server using a master key and the unique address associated with the second communication device.

16. The method according to claim 13 wherein in response to the secure server receiving a registration request from the second communication device, the method further comprises:
retrieving and sending the global public key from the secure server to the second communication device.

17. The method according to claim 13 wherein identity based encryption is used to encrypt the plaintext at the first communication device and identity based decryption is used to decrypt the encrypted plaintext at the second communication device.

18. The method according to claim 13 wherein the determination by the second communication device that a Short Message Service message received at the second communication device contains encrypted plaintext comprises:
checking, using the second communication device, if a flag provided at a first byte of the encapsulated encrypted plaintext in the Short Message Service message is set to indicate the presence of encrypted plain text.
